(19) United States
(12) Patent Application Publication
(10) Pub. No.: US 2024/0408571 A1
(43) Pub. Date: Dec. 12, 2024

(54) ADSORPTIVE FABRIC CONSTRUCTION

(71) Applicants: Natalie L. Pomerantz, Natick, MA (US); NuMat Technologies, Inc., Chicago, IL (US)

(72) Inventors: Rachelle Richardson, Chicago, IL (US); Benjamin Galphin, Charlotte, NC (US); Natalie L. Pomerantz, Newton, MA (US); Nicolaas Vermeulen, Chicago, IL (US); Edwin Alfonso Argueta Fajardo, Chicago, IL (US); William Morris, Chicago, IL (US); Patrick E. Fuller, Chicago, IL (US); Javan L. Whitney-Warner, Chicago, IL (US)

(73) Assignee: NuMat Technologies, Inc., Chicago, IL (US)

(21) Appl. No.: 18/736,108

(22) Filed: Jun. 6, 2024

Related U.S. Application Data
(60) Provisional application No. 63/507,419, filed on Jun. 9, 2023.

(51) Int. Cl. B01J 20/22; B01D 53/04; B01J 20/20; B01J 20/28; B01J 20/30; B32B 5/02; B32B 5/18; B32B 5/24; B32B 5/26; B32B 7/14; B32B 37/12

(52) U.S. Cl. CPC B01J 20/226; B01D 53/0407; B01J 20/20; B01J 20/28035; B01J 20/30; B32B 5/024; B32B 5/026; B32B 5/18; B32B 5/245; B32B 5/26; B32B 7/14; B32B 37/12; B01D 2253/102; B01D 2253/204; B01D 2253/25; B01D 2258/06; B32B 2262/106; B32B 2266/025; B32B 2266/0278; B32B 2305/026; B32B 2305/182; B32B 2305/188; B32B 2307/724; B32B 2313/04; B32B 2323/10; B32B 2327/18; B32B 2375/00; B32B 2437/00; B32B 2571/00

(57) ABSTRACT

A multi-layer fabric construction for protection from airborne toxic chemical agents comprises an optional inner comfort layer, a carbon layer, an adsorbent adhesive layer comprising a metal organic framework material, a vapor permeable layer, and an outer layer. The multi-layer fabric construction is substantially free of air pockets to reduce the thermal burden on an individual wearing a garment fabricated from the multi-layer fabric construction. The MOF can be a zirconium MOF. Also disclosed is a method of making the multi-layer fabric construction.

### CROSS-REFERENCE TO RELATED APPLICATIONS

This application claims priority from U.S. Provisional Application No. 63/507,419, filed Jun. 9, 2023, which is incorporated herein in its entirety.

### STATEMENT REGARDING FEDERALLY SPONSORED RESEARCH OR DEVELOPMENT

This invention was made with U.S. Government support under Agreement No. HDTRA 120C0023 awarded by the Defense Threat Reduction Agency/AL-AC. The Government has certain rights in the invention.

### FIELD OF THE DISCLOSURE

This disclosure relates to multi-layered fabric constructions to mitigate toxic chemical agents, to methods of making the multi-layered fabric constructions, and to articles made from the multi-layered fabric constructions. This disclosure further relates to such multi-layered fabric constructions wherein such constructions include a carbon-based material and a metal organic framework adsorptive material, to methods of making such multi-layered fabric constructions, and to articles made from such multi-layered fabric constructions.

### BACKGROUND OF THE DISCLOSURE

There is a need for fabric constructions that can offer protection against airborne contaminants, particularly toxic chemical agents, including pesticides, herbicides, and toxic industrial chemicals (TICs), and even more particularly chemical warfare agents (CWAs). There is a need for such fabric constructions that can offer protection against such toxic chemical agents through both sorptive mechanisms and decomposition mechanisms. There is further a need for such protective fabric constructions that can be made into apparel for those who might be potentially exposed to such airborne toxic chemical agents, particularly such airborne toxic chemical agents that can be absorbed through the skin.

It is known to manufacture protective apparel from fabric constructions that include one or more layers that are impervious to vapors and airborne contaminants, such as layers comprising natural or synthetic rubber materials. Such impervious layers, however, entrap heat and moisture naturally emitted from the wearer's skin, such that a fabric construction containing such impervious layers becomes intolerably uncomfortable within a very short period of time, particularly when worn in hot environments such as desert or tropical conditions. It is therefore desirable to provide protective apparel that both limits the inward flow of airborne toxic chemical agents yet permits the outward flow of naturally produced moisture and heat.

One form of protective apparel is based on fabric constructions incorporating activated carbon; typically, the activated carbon can be in the form of particles or granules disposed between layers of fabric. For example, the primary incumbent material used for protective apparel is JSLIST (Joint Service Lightweight Integrated Suit Technology). The JSLIST liner consists of a non-woven front, laminated to activated carbon spheres and bonded to a knitted back that absorbs chemical agents. The JSLIST fabric includes air gaps that enhance protection but act as insulation to increase the thermal burden significantly, such that apparel made from such fabric constructions can become uncomfortably warm for the user.

It has been attempted to eliminate the insulating air pockets from protective apparel by bonding activated carbon particles or granules to one or more internal surfaces of a fabric construction by use of an appropriate adhesive. Certain adhesives can make the resulting fabric stiff and brittle, and therefore very uncomfortable for the wearer.

Moreover, activated carbon at best only adsorbs toxic chemical agents, but it does not decompose or otherwise deactivate the toxic chemical agents. It would be desirable to provide a protective material that both adsorbs and deactivates toxic chemical agents.

U.S. Pat. No. 8,647,419 discloses an adsorptive filter material comprising a gas-permeable support, a MOF adsorbent, and an additional adsorbent in the form of activated carbon, which filter material is stated to be suitable for producing protective materials for civilian and military use.

U.S. Pat. No. 9,623,404 discloses metal organic frameworks (MOFs) for the catalytic detoxification of chemical warfare nerve agents, and a method of using a MOF comprising a metal ion and an at least bidentate organic ligand to catalytically detoxify chemical warfare nerve agents, the method including exposing the metal organic framework to the chemical warfare nerve agent and catalytically decomposing the nerve agent with the MOF.

U.S. Pat. No. 10,828,873 discloses a textile composite for the adsorption and breakdown of harmful chemical materials, the composite comprising a support layer, a sorptive and reactive material mounted on the support layer to form a protective layer which is mounted on an inner liner, and an outer shell. Preferably, the sorptive and reactive material includes zirconium hydroxide, which is distributed in the amount of at least 20 grams per square meter.

U.S. Pat. No. 11,219,785 discloses chemical and biological protective garments made from composite fabrics having a fabric cover layer and a vapor protective layer, wherein adjacent layers are laminated to one another to eliminate or substantially eliminate air gaps therebetween.

U.S. Pat. No. 11,400,331 discloses a method of detoxifying a liquid chemical agent using a surface-modified metal organic framework having an amine-based compound deposited on a surface and pores thereof, or bonded to the inside of a frame, wherein the surface modified metal organic framework comes into contact with the liquid chemical agent, a reaction with moisture in the atmosphere occurs and the liquid chemical agent is removed through a hydrolysis reaction in solution, thereby detoxifying chemical agents.

US 2022/0362738 A1 discloses a flexible material comprising a flexible substrate and a sorbent comprising zirconium hydroxide and a binder. The sorbent is applied to the flexible substrate as a dispersion, which dispersion may also include further sorbents such as a MOF, aluminum oxide, silicon-aluminum oxide, activated carbon, magnesium oxide and titanium oxide. The MOF can be a zirconium MOF such as UiO-66 or UiO-66-NH₂.

It is thus an object of the disclosure to provide a gas permeable fabric construction that can offer a user protection against a variety of airborne toxic chemical agents.

It is another object of the disclosure to provide a gas permeable fabric construction that can offer a user protection against a variety of airborne toxic chemical agents without imposing an undue thermal burden on the user.

It is yet another object of the disclosure to provide a gas permeable fabric construction that can offer a user protection against a variety of airborne toxic chemical agents, yet which has sufficient elasticity or resilience to be reasonably comfortable for a user to wear over an extended period.

It is yet another object of the disclosure to provide a method of making a gas permeable fabric construction that can offer a user protection against a variety of airborne toxic chemical agents.

It is yet another object of the disclosure to provide articles made from a gas permeable fabric construction that can offer a user protection against a variety of airborne toxic chemical agents.

Other objects, advantages, and novel features of the disclosure will be readily apparent to one skilled in the art from the disclosure and figures herein.

### SUMMARY OF THE DISCLOSURE

Disclosed herein is a multi-layered fabric construction to mitigate airborne toxic chemical agents, the construction comprising:
a. a carbon layer having an inner face and an opposing outer face;
b. a gas-permeable adsorbent-adhesive layer comprising a metal organic framework material and an adhesive, said gas-permeable adsorbent-adhesive layer having an inner face and an outer face, the inner face of the adsorbent-adhesive layer facing the outer face of the carbon fabric layer;
c. a vapor permeable layer having an inner face and an opposing outer face, with the inner face of the vapor permeable layer facing the outer face of the adsorbent-adhesive layer; and
d. an outer layer having an inner face and an opposing outer face and having its inner face facing the outer face of the vapor permeable layer.

In one embodiment, the layers of the multi-layer fabric construction are secured to one another to substantially eliminate air gaps between the layers.

In one embodiment, a plurality of columns of adhesive extends through the thickness of the adsorbent-adhesive layer, thereby to bind the layers on either side of the adsorbent-adhesive layer to one another with the adsorbent-adhesive layer disposed there between.

In one embodiment, the outer face of the vapor permeable layer is bound to the inner face of the outer layer by a gas-permeable layer of adhesive; in one embodiment, this gas-permeable layer of adhesive can be a polymerizable adhesive.

In one embodiment, the fabric construction can further comprise an inner layer secured to the inner face of the carbon layer, to promote comfort for the user. The inner layer can be secured to the inner face of the carbon layer by a gas permeable layer of adhesive; in one embodiment, this gas-permeable layer of adhesive can be a polymerizable adhesive.

In various embodiments, additional layers may be interspersed between any of the carbon layer, the adsorbent-adhesive layer, the vapor permeable layer, and the outer layer.

In one embodiment, the adsorbent-adhesive layer can provide both adsorbency and deactivation activity with respect to one or more airborne toxic chemical agents.

Also disclosed herein is a method of making a multi-layer fabric construction, the method comprising
a. providing a first subassembly comprising a carbon layer having an inner face and an outer face;
b. providing a second sub-assembly comprising an outer fabric having an inner face and an outer face, a vapor permeable layer having an inner face and an outer face, the outer face of the vapor permeable layer toward the inner face of the outer fabric;
c. providing an adsorbent-adhesive combination comprising a MOF material and adhesive; and
d. securing the first subassembly, the second subassembly, and the adsorbent-adhesive combination in a multi-layer fabric construction with the adsorbent adhesive-combination disposed between the first and second subassemblies.

In one embodiment of the method, the adsorbent-adhesive combination comprises a mixture of granules comprising a MOF material and granules comprising adhesive.

In one embodiment of the method, the adsorbent-adhesive combination comprises sheets of adhesive with MOF material disposed therebetween.

In one embodiment of the method, the first subassembly further comprises a gas permeable layer of adhesive on its outer face.

In one embodiment of the method, the second subassembly further comprises a gas permeable layer of adhesive on its inner face.

In one embodiment of the method, the adhesive on the carbon layer, the adhesive on the vapor permeable layer, and the adhesive in the MOF-adhesive combination are each independently thermal adhesives.

In one embodiment of the method, heat is applied during the securing step to facilitate the formation of adhesive bonds between the layers.

In another aspect, disclosed herein is a multi-layer fabric construction comprising a fabric layer and an adsorbent-adhesive layer, wherein the adsorbent of the adsorbent-adhesive layer comprises a zirconium MOF.

In one embodiment, the zirconium MOF includes some linker molecules comprising an amino group.

In one embodiment the MOF provides both adsorbency and decontamination activity with respect to one or more airborne toxic chemical agents.

In one embodiment, at least 55% of the amino groups of the MOF are activated amino groups of the form —NH₂.

In one embodiment, the zirconium MOF is impregnated with an inorganic metal salt.

In one embodiment, the multi-layer fabric construction comprises a fabric layer; an adsorbent-adhesive layer, wherein the adsorbent of the adsorbent-adhesive layer comprises a zirconium MOF; and a layer comprising carbon.

Also disclosed herein are articles made from the multi-layer fabric constructions, including protective apparel.

### DESCRIPTION OF THE FIGURES

FIG. 1 is a simplified illustration of an embodiment of a multi-layer fabric construction of the disclosure showing the arrangement of the various layers.

FIG. 2 is an exploded cross-sectional illustration of the embodiment of FIG. 1 showing the various layers and the adhesives that bind the layers, prior to the final assembly.

FIG. 3 is a cross sectional illustration of the embodiment of FIG. 1 after final assembly and in which the various layers are adhered together.

FIG. 4 is a simplified illustration of an alternative embodiment of a multi-layer fabric construction of the disclosure showing the arrangement of the various layers.

FIG. 5 is an exploded cross-sectional illustration of the embodiment of FIG. 4 showing the various layers and the adhesives that bind the layers, prior to the final assembly.

FIG. 6 is a cross sectional illustration of the embodiment of FIG. 4 after final assembly and in which the various layers are adhered together.

FIG. 7 is an illustration of the apparatus used for the AVLAG test, as illustrated in U.S. Pat. No. 11,219,785.

### DETAILED DESCRIPTION OF THE DISCLOSURE

The disclosure is directed to a multi-layer fabric construction that can be made into articles to provide a user with protection from a variety of airborne toxic chemical agents. In one application the multi-layer fabric construction can be made into articles of apparel to protect the wearer against a variety of airborne toxic chemical agents. The disclosure further relates to methods of making the multi-layer fabric construction, and to articles made from the multi-layer fabric construction. The fabric multi-layer construction comprises a carbon layer, an adsorbent-adhesive layer comprising at least one metal organic framework material, a vapor permeable layer, and an outer layer. An optional innermost fabric layer also can be provided for the comfort of the user.

The disclosure is further directed to a multi-layer fabric construction comprising a fabric layer and an adsorbent-adhesive combination, wherein the adsorbent of the adsorbent-adhesive combination comprises a zirconium MOF.

As used herein, the phrase “inner face” of a layer refers to that face that is toward the person who is wearing the multi-layer fabric construction as disclosed herein, or toward the object to be protected by the multi-layer fabric construction as disclosed herein.

As used herein, the phrase “outer face” of a layer refers to that face that is away from the person who is wearing the multi-layer fabric construction as disclosed herein, or away from the object to be protected, and toward the environment that contains one or more airborne toxic chemical agents.

As used herein, when a face is described as “facing” or “toward” another face, it may be in direct contact with that face or there may be additional layers disposed therebetween.

“MOF material” as used herein means an adsorbent comprising one or more optionally impregnated MOFs and optionally comprising one or more additional materials such as other adsorbents and binders. The MOF material is typically present in powder or granular form.

“Activated carbon” as used herein encompasses both non-impregnated activated carbon and activated carbon impregnated with one or more active ingredients such as triethylenediamine (TEDA).

“Adhesive layer” as used herein is a gas-permeable adhesive layer, regardless of the adhesive material from which the layer is made.

“Toxic chemical agents” as used herein includes without limitation toxic industrial chemicals, chemical warfare agents, and pesticides.

As used herein, “pesticides” are substances that are meant to control pests. A “pesticide” can be any of an herbicide, insecticide, nematicide, molluscicide, piscicide, avicide, rodenticide, bactericide, insect repellent, animal repellent, microbicide, fungicide, and lampricide.

### Multi-Layer Construction

A multi-layered fabric construction to mitigate airborne toxic chemical agents comprises:
a. a carbon layer having an inner face and an opposing outer face;
b. a gas-permeable adsorbent-adhesive layer comprising a metal organic framework (MOF) material and an adhesive, said gas-permeable adsorbent-adhesive layer having an inner face and an outer face, the inner face of the adsorbent-adhesive layer facing the outer face of the carbon layer;
c. a vapor permeable layer having an inner face and an opposing outer face, with the inner side of the vapor permeable layer facing the outer face of the adsorbent-adhesive layer; and
d. an outer layer having an inner face and an opposing outer face and having its inner face facing the outer face of the vapor permeable layer.

In one embodiment, the multi-layer fabric construction is substantially free of air gaps between the layers.

In one embodiment, a plurality of columns of adhesive extends through the thickness of the adsorbent-adhesive layer from the outer face of the carbon layer and through the adsorbent-adhesive layer comprising a metal organic framework material to the inner face of the vapor permeable layer, thereby to bind the layers on either side of the adsorbent-adhesive layer to one another with the adsorbent-adhesive layer disposed therebetween.

In one embodiment, the outer face of the vapor permeable layer is bound to the inner face of the outer layer by a gas-permeable layer of adhesive; in one embodiment, this gas-permeable layer of adhesive can be a polymerizable adhesive.

In one embodiment, the multi-layer fabric construction can further comprise an inner layer disposed inwardly of the inner face of the carbon layer, to promote comfort for the user. The inner layer can be secured to the multi-layer construction by a gas permeable layer of adhesive; in one embodiment, this gas-permeable layer of adhesive can be a polymerizable adhesive.

In various embodiments, additional layers may be interspersed between any of the optional inner layer, the carbon layer, the adsorbent-adhesive layer, the vapor permeable layer, and the outer layer.

In one embodiment, the adsorbent-adhesive layer can provide both adsorbency and decontamination activity with respect to one or more airborne toxic chemical agents.

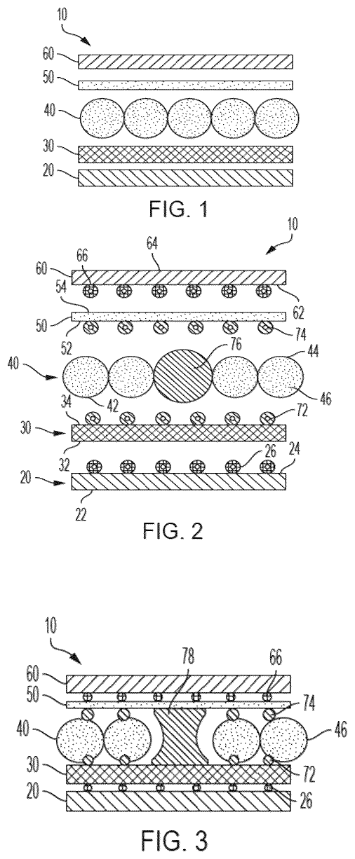

FIG. 1 illustrates a simplified cross-sectional view of an embodiment of a multi-layer fabric construction 10 comprising optional inner fabric layer 20, carbon layer 30, adsorbent-adhesive layer 40 comprising metal organic framework material, vapor permeable layer 50, and outer layer 60. FIG. 2 is an exploded cross-sectional view of the embodiment of FIG. 1 further illustrating applied adhesives and showing the relationship of the different layers to one another prior to final assembly into a multi-layer fabric construction. FIG. 3 is a cross-sectional view after final assembly and in which the various layers are adhered to form the final construction.

Optional inner fabric layer 20 is provided primarily for the comfort of a person wearing a protective garment made from textile composite 10. Therefore, inner fabric layer 20 is preferably made of a soft material that allows for a person's skin to sweat effectively. As such, inner fabric layer 20 is preferably permeable to air and water vapor and can be a flat textile material, especially a woven fabric, a knitted fabric, a stitched fabric, a laminated fabric, a textile composite, a fleece, or a non-woven fabric. Referring to FIG. 2, inner fabric layer 20 has an inner face 22 that will be toward a user's skin and may be in physical contact with a user's skin, and an outer face 24. Inner fabric layer 20 is formed from a vapor permeable fabric, which allows the passage of moisture vapor formed by perspiration and the wicking of liquid sweat away from the skin. Inner fabric layer 20 is designed mostly for comfort of the skin of a person wearing multilayer fabric construction 10 as a protective garment. Inner fabric layer 20 is preferably flexible but also strong enough to support additional layers such as described herein. Inner fabric layer 20 is desirable with respect to the comfort of the user but is not critical with regard to the protective performance of apparel made from the multi-layer fabric construction and is therefore an optional component of the multi-layer fabric composition.

Carbon layer 30 preferably comprises activated carbon, which is known as a broad-spectrum adsorbent for many airborne toxic chemical agents and can provide an effective supplement to the protection afforded by the adsorbent-adhesive layer 40. Referring again to FIG. 2, carbon layer 30 has inner face 32 and outer face 34. When optional inner fabric layer 20 is present, inner face 32 of carbon layer 30 will be disposed toward outer face 24 of inner fabric layer 20 and secured thereto with adhesive 26 as described below. In one embodiment of the multilayer fabric constructions the activated carbon is present as an integral layer such as carbon fabric or a carbon-impregnated membrane. Such an integral carbon layer facilitates ease of manufacture of the assembled construction. Activated carbon cloth suitable for use in the multi-layer fabric construction of the disclosure can be either woven or knit. Knit activated carbon fabrics may provide certain advantages of stretch and freedom of movement for apparel articles made from the multilayer fabric construction. Carbon cloth fabrics available commercially include without limitation products sold under the brand names Zorflex, Stedcarb, and Flexzorb. In one embodiment, integral activated carbon layer 30 can have an activated carbon loading of at least about 10 g/m², or at least 20 g/m², or at least 30 g/m², or at least 40 g/m², or at least 50 g/m², or at least 60 g/m², or at least 70 g/m², or at least 80 g/m², or at least 90 g/m², or at least 100 g/m².

In another embodiment (not illustrated) carbon layer 30 can be in the form of activated carbon granules, such as spherical granules. In one embodiment, the activated carbon granules can be applied with an appropriate adhesive to the outer face 24 of inner fabric layer 20, or to another intervening layer. In one embodiment, the activated carbon granules can be applied to the inner face 42 of adsorbent-adhesive layer 40.

Activated carbon, whether in the form of a cloth comprising activated carbon, a carbon-impregnated membrane, or spherical granules, is an adsorbent that can provide a good initial level of protection from many airborne toxic chemical agents, but activated carbon cloths and membranes that would be thin and flexible enough for comfort during prolonged wear may not have sufficient adsorbency to provide adequate protection for certain hazardous chemicals, while spherical granules present challenges with uniformity of distribution over a wide surface area. In addition, activated carbon only adsorbs but does not decompose or otherwise deactivate certain adsorbed hazardous chemicals, in particular certain chemical warfare agents, and therefore does not provide decontamination capability.

To provide enhanced protection for a user, adsorbent-adhesive layer 40 comprises MOF materials that can provide additional adsorbency for airborne toxic chemical agents. In some instances, the adsorbent materials of adsorbent-adhesive layer 40 also can provide decontamination of certain adsorbed toxic chemical agents.

In the embodiment illustrated in FIGS. 1-3, adsorbent-adhesive layer 40 has inner face 42 disposed toward outer face 34 of activated carbon fabric layer 30, and an outer face 44. Adsorbent-adhesive layer 40 comprises metal organic frameworks (MOF) that may be in the form of powders or granules 46. When granules are used, the MOF can be granulated with binders or other excipients to form MOF materials. Adsorbent-adhesive layer 40 is discontinuous, as described in greater detail below, to allow for air flow through the multi-layer fabric construction. Adsorbent-adhesive layer 40 further comprises adhesive, which in the embodiment of FIGS. 1-3 is initially in the form of adhesive granules 76 (see FIG. 2). Preferably adhesive granules 76 comprise thermal adhesive. Adsorbent-adhesive layer 40 also may comprise other adsorbents. MOF materials suitable for use in the adsorbent-adhesive layer 40 of multi-layer fabric construction 10 are described in more detail below. In one embodiment, the MOF-containing powders or granules 46 may have particle sizes in the range of 150 microns-840 microns (20×100 mesh), or preferably in the range of 250 microns-400 microns (40×60 mesh). In one embodiment, the MOF-containing powders or granules include particles having diameter of at least about 100 microns, or at least about 200 microns, or at least about 300 microns, or at least about 400 microns, or at least about 500 microns, or at least about 600 microns, or at least about 700 microns, or at least about 800 microns. The use of MOF in the form of granules allows for more precise loading of the MOF across the multi-layer fabric construction, and also allows for a higher loading of the MOF than can be achieved with other techniques. MOF can be present across the area of the fabric construction in loadings of at least about 50 g/m², or at least about 100 g/m², or at least about 150 g/m², or at least about 200 g/m², or at least about 250 g/m², or at least about 300 g/m², or at least about 350 g/m², or at least about 400 g/m², measured as the amount of MOF active ingredient in the MOF material.

Vapor permeable layer 50 has an inner face 52 disposed toward outer face 44 of adsorbent-adhesive layer 40, and an outer face 54. Vapor permeable layer 50 can be a material that is substantially impervious to penetration by aerosol particles (such as dust and aerosolized chemical agents, for example, dusty mustard, or biological agents). In one embodiment, vapor permeable layer 50 can comprise a porous membrane such as, for example, expanded polytetrafluoroethylene (ePTFE), preferably microporous ePTFE, or other polymer membranes such as polyurethane (PU), polypropylene, and GORE-TEX ePE (expanded polyethylene) membrane available from Gore-Tex. The weight of vapor permeable layer 50 can range from about 0.2 osy to about 2.0 osy (ounces per square yard), preferably from about 0.5 osy to about 1.0 osy; or about 13-38 g/m², preferably 13-19 g/m². In one embodiment the vapor permeable layer 50 will have a thickness of about 25-35 microns; in another embodiment vapor permeable layer 50 will have a thickness of about 50-60 microns. In one embodiment the vapor permeable layer 50 has a hydrostatic pressure of at least 6000 mm, or at least 7000 mm, or at least 8000 mm, or at least 9000 mm, or at least 10,000 mm. Another feature that affects flexibility and user comfort is elongation at break. In one embodiment the vapor permeable layer 50 will have elongation at break of at least 100%, or at least 110%, or at least 120%, or at least 130%, or at least 140%, or at least 150%.

In another embodiment vapor permeable layer 50 can comprise a fabric, which can be a woven fabric or a non-woven fabric. A non-woven fabric can be made by known processes such as electrospinning or a meltblow process. Representative non-woven fabrics suitable for use as a vapor permeable layer include without limitation those described in U.S. Pat. No. 8,366,816, the disclosure of which is incorporated herein by reference.

Vapor permeable layer 50 serves to disperse incoming airborne toxic chemical agents such as vapors or aerosols before they impinge on adsorbent-adhesive layer 40. This dispersion creates a longer flow path of the contaminant through the multi-layer construction and enhances adsorption of the contaminants by adsorption-adhesive layer 40 by breaking down the incoming contaminants into smaller droplets. Aerosols that do pass through vapor permeable layer 50 will be dispersed into smaller droplets and will thereby become more susceptible to adsorption by the MOF materials of adsorbent layer 40. Vapors that pass through vapor permeable layer 50 also can be adsorbed by the MOF materials of adsorbent layer 40. Vapor permeable layer 50 also allows moisture and sweat generated by an individual wearing a garment made from the multi-layer construction to pass outwardly to the environment. To provide for this functionality, it is desirable for vapor permeable layer 50 to have a water vapor transmission as measured by ASTM E96:95, Procedure B of at least 500 g/m²/24 hr, preferably at least 600 g/m²/24 hr, more preferably at least 700 g/m²/24 hr, or at least 750 g/m²/24 hr.

Outer layer 60 has an inner face 62 disposed toward outer face 54 of vapor permeable layer 50, and an outer face 64. Outer layer 60 can include, for example, fire resistant or non-fire-resistant materials, stretch or non-stretch fabrics, knit or woven fabric materials that can be, for example, aramid-based flame-resistant material, cotton, nylon, blends such as cotton blends and nylon/cotton blends, polyester or polyester blends. The weight of outer layer 60 can range from about 2.0 osy (ounces per square yard) to about 7.5 osy, preferably from about 4.5 osy to about 6.0 osy; or in one embodiment 150-250 g/m², or 180-220 g/m². Outer face 64 of outer layer 60 can be designed to face the external environment (e.g. the outside of the garment in which protective multi-layer fabric construction 10 is used that can include sunlight, rain, gas agents, aerosols and other external environmental conditions) and can also optionally include a repellant coating, such as, for example, a liquid repellent coating (such as silica based liquid repellent coatings or perfluoronated carbon based liquid repellent coatings).

Optional inner layer 20 can be secured to carbon fabric layer 30 with a layer of adhesive 26 disposed between outer face 24 of optional inner layer 20 and inner face 32 of carbon layer 30. Adhesive layer 26 is discontinuous to allow release of heat and moisture from an individual wearing an article of clothing made from multi-layer fabric construction 10. Adhesive layer 26 can comprise either a thermal adhesive or a polymerizable adhesive. Advantageously, use of a polymerizable adhesive will prevent shifting of carbon layer 30 with respect to the inner layer 20 in subsequent thermal processing steps. Suitable polymerizable adhesives include without limitation hot melt adhesives such as those based on polyurethane or polyolefin and available from Jowat Adhesives or Henkel. Adhesive layer 26 can be applied as a discontinuous pattern by methods such as spraying, or gravure printing with a patterned roller, wherein the pattern on the roller provides the desired pattern of adhesive on the fabric surface; for example, the adhesive can be applied as a matrix of printed dots. Adhesive layer 26 can be applied at a loading of about 5-50 g/m². Adhesive layer 26 is applied to either surface 24 of inner layer 20 or surface 32 of carbon layer 30 or both; the two layers are pressed together; and the adhesive is allowed to cure.

Adsorbent-adhesive layer 40 is secured between carbon layer 30 and vapor permeable layer 50 by an adhesive, which is preferably a thermal adhesive, such as a copolyamide adhesive or a copolyester adhesive. Thermal adhesives are preferred for their flexibility and resilience. The thermal adhesive will have a melt temperature not lower than the environment in which it is expected that an article made from the multi-layer fabric construction will be used. In the embodiment illustrated in FIGS. 1-3, an adhesive layer 72 is applied to outer surface 34 of carbon layer 30, an adhesive layer 74 is applied to inner surface 52 of vapor permeable layer 50, and adhesive granules 76 are mixed with the MOF granules 46 of adsorbent-adhesive layer 40. In one embodiment of a method of making the multilayer fabric construction 10, adhesive layer 72 is applied to outer surface 34 of carbon layer 30 as a discontinuous pattern; for example, it may be applied as a matrix of small adhesive dots. In one embodiment, molten adhesive is applied to a roller having a textured surface and rolled over outer surface 34. Similarly, adhesive layer 74 is discontinuous, and can be applied to the inner surface 52 of vapor permeable layer 50 in the same manner. The MOF granules 46 are mixed with adhesive granules 76 in a MOF granule: adhesive granule mass ratio of about 9:1; or 8:1, or 7:1, or 6:1, or 5:1, or 4:1, or 3:1, or 2:1, or 1:1; preferably in the range of about 3:1-5:1, and most preferably about 4:1. At least some of the adhesive granules 76 will have a diameter at least as great as the diameter of the MOF particles 46. In one embodiment the adhesive particles will have average particle size in the range of about 200-500 microns. In the embodiment of FIGS. 1-3, in the final construction the adsorbent-adhesive combination can comprise adsorbent 46, adhesive 72, adhesive 74, and adhesive 76, wherein some of adhesive 76 may be deformed into columns 78, as described below.

Inner face 62 of outer layer 60 is secured to outer face 54 of vapor permeable layer 50 by a layer of adhesive 66. Adhesive layer 66 will be discontinuous to promote permeability of the fabric construction 10. Adhesive layer 66 comprises a thermal adhesive or a polymerizable adhesive. Advantageously, use of a polymerizable adhesive will prevent shifting of outer layer 60 with respect to the vapor permeable layer 50 in subsequent thermal processing steps. Suitable polymerizable adhesives include the same adhesives used for adhesive layer 26. Adhesive layer 66 can be applied by methods such spraying, or gravure printing with a patterned roller, wherein the pattern on the roller provides the desired pattern of adhesive on the fabric surface. Adhesive layer 66 is applied to either surface 54 of vapor permeable layer 50 or to surface 62 of outer layer 60, or to both, the vapor permeable layer 50 and the outer layer 60 are pressed together, and the adhesive is allowed to cure.

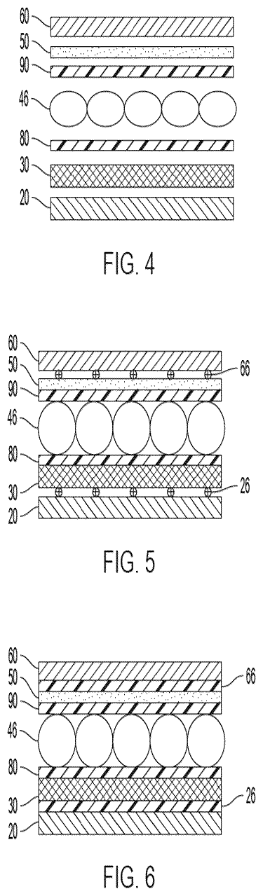

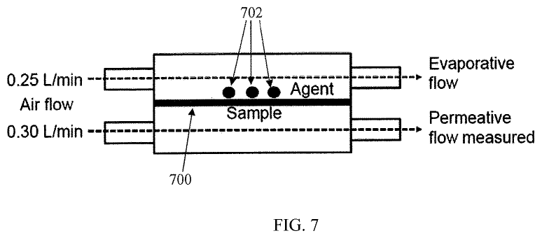

In an alternative embodiment illustrated in FIGS. 4-6, adhesive between carbon layer 30 and adsorbent-adhesive layer 40 can comprise adhesive layer 80, and adhesive between adsorbent-adhesive layer 40 and vapor permeable layer 50 can comprise adhesive layer 90. Layers 80 and 90 each can be in the form of a gas-permeable adhesive sheet such as those available under the brand names StitchWitch, Bostik PE120. When gas-permeable adhesive sheets are used for the adhesive layers 80 and 90, then the use of adhesive granules 76 in adsorbent layer 40 is optional. Further, when adhesive sheets are used for adhesive layers 80 and 90, then the application of adhesive to the outer face 34 of carbon layer 30 and to the inner face 52 of vapor permeable layer 50 is also optional. In the embodiment of FIGS. 4-6, in the final construction the adsorbent-adhesive combination can comprise adhesive layer 80, adsorbent 46, adhesive layer 90, and optional adhesives.

In one aspect of the disclosure, a multi-layer fabric construction to mitigate airborne toxic chemical agents comprises a fabric layer and a gas permeable adsorbent-adhesive layer, wherein the adsorbent of the gas-permeable adsorbent-adhesive layer comprises a MOF material comprising a zirconium MOF. The fabric layer and the adsorbent-adhesive layer are distinct layers in the construction and are distinguished from constructions in which a fabric is dip coated into an emulsion containing one or more adsorbents to make a single fabric-adsorbent layer. In one embodiment, the multi-layer fabric construction comprising a zirconium MOF further comprises a carbon layer. In one embodiment, the multi-layer fabric construction comprising a zirconium MOF further comprises a vapor permeable layer. In one embodiment, the zirconium MOF includes some linker molecules comprising an amino group. In one embodiment, at least 55% of the amino groups of the zirconium MOF are activated amino groups of the form —NH₂. In one embodiment, the zirconium MOF is impregnated with an inorganic metal salt.

For each of the embodiments disclosed herein, airborne toxic chemical agents will first contact outer layer 60. Some of the agents may be repelled by outer layer 60 but some may penetrate to vapor permeable layer 50. As the agents penetrate vapor permeable layer 50, any large droplets will be dispersed into smaller droplets, and all of the toxic chemical agent molecules will have a longer path to reach adhesive-absorbent layer 40. The toxic chemical agent molecules will also be more evenly dispersed over the area of adsorbent-adhesive layer 40. When the toxic chemical agents contact the MOF in adsorbent-adhesive layer 40 they will be adsorbed by the MOF. Further, depending on the particular MOF(s) in layer 40 and the particular toxic chemical agents(s), the MOFs will cause the toxic chemical agents to decompose or otherwise be chemically deactivated. Any agent that is not adsorbed in layer 40 will then pass to carbon layer 30 where it will be adsorbed. The decomposition products of the deactivated toxic chemical agent may be adsorbed by either the MOF of layer 40 or the carbon of layer 30. Advantageously, the fact that at least some of the toxic chemical agent has been decomposed or otherwise deactivated means that the exposed fabric construction will be easier to handle safely for subsequent re-use or disposal as compared to fabric constructions in which toxic chemical agents are adsorbed but not deactivated.

Further, in each of the disclosed embodiments, heat and moisture emitted from the skin of an individual wearing a garment constructed from the multi-layer fabric construction will pass through optional inner layer 20, carbon layer 30, adsorbent-adhesive layer 40, vapor permeable layer 50, and outer layer 60. The multi-layer construction has no substantial insulating air pockets to hold in heat and moisture emitted from the user's skin. Garments made from the multi-layer construction are therefore more comfortable than garments made from prior constructions, and can be worn for longer periods of time, while providing greater protection for the user.

### Method of Assembly

In one embodiment, a method of making a multi-layer fabric construction comprises the steps of:
a. providing a first subassembly comprising a carbon layer 30 having an inner face 32 and an outer face 34, and optionally having a gas-permeable layer of adhesive on said outer face 34;
b. providing a second sub-assembly comprising an outer fabric 60 having an inner face 62 and an outer face 64, a vapor permeable layer 50 having an inner face 52 and an outer face 54, the outer face 54 of the vapor permeable layer 50 being adhesively secured to the inner face 62 of the outer fabric 60 by an adhesive layer 66, and optionally a gas-permeable layer 74 of adhesive on the inner face 52 of the vapor permeable layer 50;
c. providing an adsorbent MOF-adhesive combination comprising an adhesive and a MOF material; and
d. securing the first subassembly, the second subassembly, and the adsorbent-adhesive combination in a multi-layer fabric construction with the adsorbent adhesive-combination disposed between the first and second subassemblies.

In one embodiment of the method, the first subassembly will further comprise an inner fabric layer 20 adhered to inner face 32 of carbon layer 30 with gas-permeable adhesive layer 26.

In an embodiment in which the adsorbent-adhesive mixture comprises adsorbent MOF granules and adhesive granules, and optional adhesive layers 72 and 74 are present, then in the step of securing said first subassembly to said second subassembly with a layer 40 of said mixture comprising MOF granules and adhesive granules disposed therebetween, said layer 40 comprising MOF granules and adhesive granules is in contact with both gas-permeable layer 72 of adhesive on the outer face 32 of the carbon fabric 30 of the first subassembly and gas permeable layer 74 of adhesive on inner surface 52 of vapor permeable layer 50 of the second subassembly.

In one embodiment of the method of assembly, the MOF-adhesive mixture is deposited on adhesive layer 72 of the first subassembly, and is then overlaid with the second subassembly with adhesive layer 74 against the granular MOF adhesive mixture; or, the granular MOF-adhesive mixture can be deposited on adhesive layer 76 of the second subassembly, and is then overlaid with the first sub-assembly with adhesive layer 72 against the granular MOF-adhesive mixture. The deposition of the MOF adhesive mixture can be accomplished by techniques such as spreading, scattering, or other techniques known in the art. The assembled layers are then heated under pressure; alternatively, the layers can be secured together by roll lamination. Referring to FIG. 3, as adhesive layers 72 and 74 and adhesive granules 76 soften, the adhesive layers 72 and 74 will adhere to the adjacent MOF granules, and further in some locations softened adhesive granules 76 will deform and extend to join to adhesive layer 72 and adhesive layer 74, to create adhesive columns 78 that extend through adsorbent layer 40 to secure carbon layer 30 to vapor permeable layer 50 with MOF granules 46 secured therebetween. Advantageously, the MOF granules 46 retain adsorbency to provide additional protection against airborne toxic chemical agents.

The adhesives layers 26, 72, 74 and 66 each can be applied to their respective supportive layers in the form of dot matrix adhesives, web adhesives, other adhesive patterns or methods including gravure rolls, reverse gravure rolls, nanofiber adhesives and other methods. Preferably, the lamination eliminates or substantially eliminates air gaps from the boundary between adjacent layers. As a result of removing or substantially removing air gaps, thermal transfer, for example, heat generated from the wearer of garment constructed of an embodiment of the protective composite fabrics of the present disclosure, is more efficient from one side of the protective composite fabric to the other side than if such air gaps were present. This is because air gaps in a protective composite fabric layer can contribute to poor heat transfer because air is an insulator.

In an alternative embodiment, a method of making a multi-layer fabric construction comprises the steps of:
a. providing a first subassembly comprising a carbon layer 30 having an inner face 32 and an outer face 34, and optionally having a gas-permeable layer of adhesive in the form of an adhesive sheet on said outer face 34;
b. providing a second sub-assembly comprising an outer fabric 60 having an inner face 62 and an outer face 64, a vapor permeable layer 50 having an inner face 52 and an outer face 54, the outer face 54 of the vapor permeable layer 50 being adhesively secured to the inner face 62 of the outer fabric 60 by an adhesive layer 66, and optionally a gas-permeable layer of adhesive in the form of an adhesive sheet on the inner face 52 of the vapor permeable layer 50;
c. providing an adsorbent-containing composition comprising an adsorbent MOF material and optionally comprising an adhesive; and
d. securing the first subassembly, the second subassembly, and the adsorbent-containing composition in a multi-layer fabric construction with the adsorbent-containing composition disposed between the first and second subassemblies.

### Metal Organic Frameworks

MOFs are the coordination product of metal ions and at least bidentate organic ligands. MOFs are made up of corner metal units comprising metal ion atoms and linker, i.e. ligand, molecules which form a framework having high surface area and uniformly sized pores, or pores of different pre-determined sizes. While it is known to use metal oxides in multi-layer fabric constructions, the use of MOFs having much higher surface areas offer greater adsorbency and greater decontamination capacity per unit area of the fabric construction.

Representative metals (M) which can be used to prepare MOFs include but are not limited to Zr, V, Al, Fe, Cr, Ti, Hf, Cu, Zn, Ni, Hf, In, Ce, and combinations thereof. For use in the multi-layer fabric constructions disclosed herein, it is preferred to use MOFs having corner metal units comprising a metal that adsorbs or is otherwise reactive with an airborne toxic chemical agent of interest. A preferred set or subset of the above metals includes but is not limited to Zr, Al, Fe, Cu, or Zn and combinations thereof, with Zr and Fe being particularly preferred.

The organic ligands which react with the metal ions to form the framework structure preferably include at least one organic ligand which contains an aryl amino group or a combination of at least one organic ligand which contains an aryl amino group and at least one organic ligand which does not contain an amino group. Examples of organic ligands containing an aryl amino group include but are not limited to 2-aminobenzene-1,4 dicarboxylic acid (NH₂-BDC), 5-aminoisophthalic acid, 3-aminobenzoic acid, 4-aminobenzoic acid and mixtures thereof. Examples of organic ligands which do not contain an aryl amino group include but are not limited to terephthalic acid (BDC), isophthalic acid, benzoic acid, trimesic acid, acrylic acid, and mixtures thereof. When the ligand is a combination of at least one organic ligand containing an aryl amino group and at least one organic ligand which does not contain an amino group, the molar ratio of amino containing:non-amino containing ligand varies from 1:99 to 99:1 or from 10:90 to 90:10 or from 20:80 to 80:20 or from 30:70 to 70:30 or from 40:60 to 60:40 or 50:50. The amino function also can be added to the MOF by post synthesis methods.

The MOFs to be used in the multi-layer fabric construction as disclosed herein may also comprise an inorganic metal (M′) salt which is impregnated onto the surface of the MOF or in the pores of the MOF. The M′ metal includes but is not limited to Li, Na, K, Mg, Ca, Sr, Ba, Mn, Sc, Y, Ti, Zr, Hf, V, Cr, Mo, W, Fe, Co, Ni, Cu, Ag, Zn, Cd, Al, Ga, In, Sn, Pb, and mixtures thereof. The M and M′ metals can be the same or different. It is preferred that the M′ metal be different from the M metal. The amount of metal salt impregnated on the MOF can vary considerably but is usually from about 1 wt % to about 70 wt. %, or from about 5 wt. % to about 65 wt. % or from about 10 wt. % to about 60 wt. % or from about 15 wt. % to about 55 wt. % or from about 20 wt. % to about 50 wt. % or from about 25 wt. % to about 45 wt. % as the metal. The inorganic M′ salt can be an anhydrous or hydrated salt selected from a halide, sulfate, carbonate, nitrate, or mixtures thereof. In one embodiment the M′ salt is a hydrous or anhydrous halide salt.

In one embodiment, the metal-impregnated MOFs may have a static ammonia capacity measured at 10 Torr and 25° C. of at least 4 mmol/g, or at least 5 mmol/g, or at least 6 mmol/g, or at least 8 mmol/g, or at least 10, mmol/g or at least 15, mmol/g or at least 20 mmol/g. In one embodiment the metal-impregnated MOF substantially retains its capacity for acidic TICs relative to the non-impregnated MOF. Particularly, it retains about 80% of its adsorption capacity for at least one acidic TIC.

In one embodiment the MOFs have a Brunauer-Emmett-Teller (BET) surface area of at least 1,000 or at least 1,100 m²/g, or at least 1,200 m²/g, or at least 1,300 m²/g, or at least 1,400 m²/g.

The MOFs may be synthesized by known methods. MOFs and impregnated MOFs suitable for use in the multi-layer fabric constructions and methods of their preparation include those disclosed in US Patent Application Publication US 2021/0379560 and US Patent Application Publication No. US2021/0379559A1, the disclosures of which are incorporated herein by reference in their entireties.

The metal compound that is the source of the metal M and the one or more ligands are mixed in a solvent or a mixture of solvents.

Optionally an acid can be present in the reaction mixture during the MOF synthesis. In one embodiment the acid present during the MOF synthesis comprises a mono-carboxylic acid. such as formic acid, acetic acid, benzoic acid, dichloroacetic acid, trifluoroacetic acid and mixtures thereof. In one embodiment the acid present during the MOF synthesis further comprises an inorganic acid such as hydrochloric acid, nitric acid, or sulfuric acid, or mixtures thereof. In one embodiment the acid present during the MOF synthesis comprises a mixture of a mono-carboxylic acid and an inorganic acid.

The reaction mixture is reacted at a temperature and time to form the desired MOF. Reaction temperature can vary from about 50° C. to about 200° C. and for a time selected from about 1 hr. to about 78 hr. The resulting MOF powder is isolated by filtration, centrifugation, etc. In some embodiments, the isolated MOF can be washed with an acid composition comprising an inorganic acid, or a mixture of one or more inorganic acids and one or more organic acids. Preferred inorganic acids include hydrochloric acid, nitric acid, and sulfuric acid. Preferred organic acids include formic acid.

If the MOF is to be impregnated, the MOF is next contacted with a solution of the metal salt that is a source of the metal M′, thereby impregnating the metal (M′) salt onto the MOF. Specific examples include but are not limited to magnesium chloride, nickel chloride, manganese chloride, zinc chloride, nickel nitrate, magnesium nitrate, nickel sulfate, nickel carbonate. In one embodiment the metal salt is NiCl₂·6H₂O. In one embodiment the metal salt is MgCl₂ (anhydrous). In one embodiment the metal salt is MnCl₂·4H₂O. In one embodiment the metal salt is ZnCl₂ (anhydrous). In one embodiment the metal salt is a hydrated form of ZnCl₂.

The metal-impregnated MOF can be formed into various shapes as discussed below. Where the step of forming the MOF powder into a shaped body is used, the impregnation step can occur before, during, or after the steps of incorporating a binder and forming the shaped body.

In one embodiment the dried MOF powder is granulated with a binder. Examples of inorganic binders include but are not limited to clays such as kaolin, attapulgite, and boehmite, aluminas, silicas, metal oxides, and mixtures thereof. Specific examples of organic binders include but are not limited to polymers, e.g., polyvinylpyrrolidone (PVP), starches, gelatin, cellulose, cellulose derivatives, sucrose, polyethylene glycol, chitosan, and mixtures thereof. Means of incorporating a binder in a MOF composition and forming granules or other shaped bodies will be understood by those skilled in the art.

The MOF materials to be used in the multi-layer fabric constructions as disclosed herein comprise one or more optionally impregnated MOFs, optionally one or more binders, and optionally one or more additional adsorbent materials or other excipients. In one embodiment, the optionally impregnated MOFs are present in the MOF materials as at least 50 wt %, or at least 60 wt %, or at least 70 wt %, or at least 80 wt %, or at least 90 wt %, or at least 95 wt % of the total MOF materials.

### Manufactured Articles

Embodiments of protective garments that include protective composite fabrics of the present disclosure may include one piece or multi-piece (e.g., two-piece) garments. Such protective garments can be configured to cover a substantial portion of the wearer including the head, neck, torso, arms and legs. Such protective garments can also be configured to cover the hands and feet through the use of gloves and boots, respectively, that can include protective composite fabrics of the present disclosure and be separate or integral to the protective garment.

The multi-layer fabric construction as disclosed herein also can be used to construct other articles to provide protection against hazardous airborne contaminants. For example, the multi-layer fabric as disclosed herein can be used in the construction of air filters, or protective packaging, or protective structures such as tents or parts thereof, or to provide protective articles for buildings or vehicles.

In one embodiment the multi-layer fabric construction has an AVLAG value of less than 0.05 μg/cm² as measured by TOP 8-2-501A.

In one embodiment the multi-layer fabric construction has a DMMP breakthrough time of at least 700 minutes as measured by the test method described herein.

In one embodiment, the multi-layer fabric construction has a water vapor transmission rate of at least 1000 g/m²/24 h as measured by ASTM E 96 Method B.

In one embodiment, the multi-layer fabric construction has air permeability of at least 0.50 cubic feet per minute (CFM) as measured by ASTM d 737, Air Permeability of Textile Fabrics.

In one embodiment, the multi-layer fabric construction has a thermal resistance of less than 0.40 clo units as measured by the sweating guarded hot plate (SGHP) test of ASTM F1868 procedure Part C (Dry).

### EXAMPLES

### Samples

Various fabric composites comprising layers of textiles glued together, with or without an adsorbent layer or other intervening layers, were prepared and evaluated. The composites included composites in accordance with the disclosure herein, and control laminates and comparative composites. In each sample the vapor permeable layer was a porous membrane. Adhesive was applied between the layers in a discontinuous pattern. In the composites described below the following materials were used. When used, the MOF was present as about 150±20 g/m² determined as the amount of active MOF ingredient. The MOF granules were mixed with granules of a thermally active co-polyester adhesive in a MOF: adhesive ratio in the range of about 3:1 to 5:1. When used, the carbon fabric had a density of about 130 g/m².
ePTFE—expanded Polytetrafluoroethylene membrane
HD Knit—Flame Resistant Modacrylic, Tencel, Para aramid, spandex knit blend
MOF A—a MOF comprising Zr and ligands of 2-aminobenzene-1,4-dicarboxylic acid, prepared in accordance with the method described in US20210379560A1
MOF B—UiO-66
MOF C—MOF-808 comprising Zr and ligands of 1,3,5-tricarboxylic acid
Protective Garment 100—a fabric of a standard duty uniform
Protective Garment 101—a baseline Chem/Bio protective garment
PU-Polyurethane membrane, 25-35 μm thick, 13.0-19.0 g/m²
Std. Knit—Flame Resistant Modacrylic, Rayon jersey knit
Std. Woven—Nylon, Cotton blend woven ripstop

TABLE 1

| | | Inner | Carbon | MOF | | Porous | Outer |
|---|---|---|---|---|---|---|---|
| | | Fabric | Form | Granules | Binder | Membrane | Fabric |
| Control | A | Std. Knit | — | — | — | — | Std. Woven |
| Samples | B | Std. Knit | — | — | — | ePTFE | Std. Woven |
| | C | Std. Knit | Fabric | — | — | PU | Std. Woven |
| | D | Std. Knit | Granules | — | — | — | Std. Woven |
| Examples | 1 | Std. Knit | — | MOF A | Colloidal | — | Std. Woven |
| | | | | | silica | | |
| | 2 | Std. Knit | — | MOF B | Colloidal | — | Std. Woven |
| | | | | | silica | | |
| | 3 | Std. Knit | — | MOF C | Colloidal | — | Std. Woven |
| | | | | | silica | | |
| | 4 | Std. Knit | — | MOF A | Chitosan | — | Std. Woven |
| | 5 | Std. Knit | — | MOF A | Colloidal | ePTFE | Std. Woven |
| | | | | | silica | | |
| | 6 | Std. Knit | — | MOF A | Colloidal | Poly- | Std. Woven |
| | | | | | silica | propylene | |
| | 7 | Std. Knit | — | MOF A | Colloidal | PU | Std. Woven |
| | | | | | silica | | |
| | 8 | Std. Knit | Granules | MOF A | Colloidal | ePTFE | Std. Woven |
| | | | | | silica | | |
| | 9 | Std. Knit | Granules | MOF A | Colloidal | Poly- | Std. Woven |
| | | | | | silica | propylene | |
| | 10 | Std. Knit | Fabric | MOF A | Colloidal | — | Std. Woven |
| | | | | | silica | | |
| Examples | 11 | Std. Knit | Fabric | MOF A | Colloidal | ePTFE | Std. Woven |
| | | | | | silica | | |
| | 12 | Std. Knit | Fabric | MOF A | Colloidal | Poly- | Std. Woven |
| | | | | | silica | propylene | |
| | 13 | Std. Knit | Fabric | MOF A | Colloidal | PU | Std. Woven |
| | | | | | silica | | |
| | 14 | Std. Knit | Fabric | MOF A | Colloidal | ePTFE | HD Knit |
| | | | | | silica | | |
| | 15 | Std. Knit | Fabric | MOF A | Colloidal | PU | HD Knit |
| | | | | | silica | | |

Each of the Control Samples and Examples set forth in Table 1 represents a laminated construction, prepared by providing discontinuous layers of adhesives on surfaces to be adhered, assembling the layers in desired arrangement, and pressing the assembled layers in a heat press. All Control Samples and Examples layers are presented in the order of arrangement from inside to outside.

Laminates without a MOF adsorbent were constructed as controls against which to test the Examples listed above. Control Sample A consisted of a Std. Knit textile and a Std. Woven textile. Control Sample B consisted of a Std. Knit textile, an ePTFE membrane, and a Std. Woven textile. Control Sample C consisted of a Std. Knit textile, a carbon fabric, a PU membrane, and a Std. Woven textile. Control Sample D consisted of a Std. Knit textile, carbon granules, and a Std. Woven textile.

Example 1 consisted of a Std. Knit textile, MOF A granules formed with colloidal silica binder, and a Std. Woven textile; Example 2 consisted of a Std. Knit textile, MOF B granules formed with colloidal silica binder, and a Std. Woven textile; Example 3 consisted of a Std. Knit textile, MOF C granules formed with colloidal silica binder, and a Std. Woven textile. Example 4 consisted of a Std. Knit textile, MOF A granules formed with chitosan binder, and a Std. Woven textile. Example 5 consisted of a Std. Knit textile, MOF A granules formed with colloidal silica binder, an ePTFE membrane, and a Std. Woven textile; Example 6 consisted of a Std. Knit textile, MOF A granules formed with colloidal silica binder, a polypropylene membrane, and a Std. Woven textile; Example 7 consisted of a Std. Knit textile, MOF A granules formed with colloidal silica inder, a PU membrane, and a Std. Woven textile. Example 8 consisted of a Std. Knit textile, carbon granules, MOF A granules formed with colloidal silica binder, an ePTFE membrane, and a Std. Woven textile; Example 9 consisted of a Std. Knit textile, carbon granules, MOF A granules formed with colloidal silica binder, a polypropylene membrane, and a Std. Woven textile. Example 10 consisted of a Std. Knit textile, a carbon fabric, MOF A granules formed with colloidal silica binder, and a Std. Woven textile.

Example 11 consisted of a Std. Knit textile, a carbon fabric, MOF A granules formed with colloidal silica binder, an ePTFE membrane, and a Std. Woven textile. Example 12 consisted of a Std. Knit textile, a carbon fabric, MOF A granules formed with colloidal silica binder, a polypropylene membrane, and a Std. Woven textile. Example 13 consisted of a Std. Knit textile, a carbon fabric, MOF A granules formed with colloidal silica binder, a PU membrane, and a Std. Woven textile. Example 14 consisted of a Std. Knit textile, a carbon fabric, MOF A granules formed with colloidal silica binder, an ePTFE membrane, and an HD Knit textile. Example 15 consisted of a Std. Knit textile, a carbon fabric, MOF A granules formed with colloidal silica binder, a PU membrane, and an HD Knit textile.

### Test Methods

In the following test methods, the term permeation with respect to chemical protective clothing means the movements of chemicals as molecules through a protective clothing material by the processes of (1) absorption of the chemical into the contact surface of the materials, (2) diffusion of the adsorbed molecules throughout the material, and (3) desorption of the chemical from the opposite surface of the material.
AVLAG. Aerosol vapor liquid assessment group (AVLAG) was run in a dual-flow apparatus illustrated in FIG. 4 according to TOP 8-2-501A, as described and illustrated in U.S. Pat. No. 11,219,785. In the method used, streams of air flowing across the top and bottom of the sample swatch 700 where agent 702 included 1 μL liquid drops of mustard (HD) or nerve agent (GD) were used to challenge the sample swatch 700 at concentrations of 10 g/m² [1000 μg/cm²]. Cumulative agent permeation values were measured at 1 hour and 24 hours and then divided by the area of the swatch to determine a normalized permeation of HD and GD through the samples (μg/cm²). Readings were made of permeative flow 704 using thermal desorption and <MDL means that the reading was below the minimum detection limit of 0.015 μg/cm².
DMMP. Dimethyl methylphosphonate (DMMP) permeation through a sample swatch was tested using an in-house dual flow test based on ASTM method F739-12, wherein a circular sample swatch 35 mm in diameter was secured between two halves of an ASTM Permeation Test Cell. The entire system, including the test cell, the sparger of the challenge agent, and the tubing to the analyzer was maintained at a temperature of 50° C.+/−3° C. using electric heating. A challenge stream was created by flowing 5 SCCM of nitrogen through a sparger of DMMP and then diluting that stream with 95 SCCM of dry nitrogen.
   a. Using actuated valves to isolate the challenge stream from the test cell and sample, the signal generated by the challenge stream was quantified via Gas Chromatography with a Flame Photometric Detector (GC-FPD), injecting the stream onto the column for 30 seconds at a rate of 4 SCCM every 3-4 minutes. Within the instrument, Helium was used as a carrier gas. This was done for 11 total scans. The signal peak of the final 10 scans was then integrated and averaged to give a “challenge signal” value. The first scan allowed for equilibration of the aerosolized stream from the sparger.
   b. Using automatically-controlled actuated valves and mass flow controllers, the challenge stream was stopped and isolated from the piping towards the injection port. A 150 SCCM flow of dry nitrogen was then passed through that tubing in order to purge the line of any residual DMMP that might create a GC-FPD signal. This was done for 40 injections, until the instrument read a signal of <1% of the average challenge signal.
   c. Using automatically-controlled actuated valves, the challenge stream was then restarted and redirected to flow along one side of the sample within the test cell while 100 SCCM of dry nitrogen was swept across the opposite side of the sample within the test cell and directed towards the GC injection port, with the same injection rate of 4 SCCM. The balance of flow was flowed through small columns of carbon in order to capture any aerosolized DMMP or breakdown products before venting to the atmosphere. The stream flow rates at the outlet of the test cell and vent near the GC injection port were measured and recorded in order to ensure an approximately equal flow on each side of the test cell (meaning permeation was diffusive and not due to forced flow) and mass flow balance of 100%+/−3%. The pressure difference across the sample was also measured at 0 psig to validate diffusive rather than forced flow.
   d. The permeation of aerosolized DMMP over time was quantified by measuring the signal of the 100 SCCM nitrogen stream on the non-challenged side of the fabric semi-continuously, injecting into the GC every 4 minutes, and normalizing that value to the average challenge stream signal from step (1). The breakthrough time was the injection time after starting step (3) at which the GC-FPD signal exceeded the baseline signal at the start of step (3) by >2% of the challenge signal.
WVTR. Water vapor transmission rate (WVTR) was determined using ASTM E 96 Method B for 24 hours, using samples of face area 30 cm² at 23° C., 50% relative humidity difference between the two sides of the sample.
Air permeability was measured using ASTM D 737, Air Permeability of Textile Fabrics.
Thermal resistance testing using a sweating guarded hot plate (SGHP) ASTM F1868 procedure Part C (Dry) was used to measure thermal resistance (Rct) in which the hot plate was kept at 35° C. in a climatic chamber regulated to 25° C. in ambient humidity while air is flowed across the top of the fabric at 1 m/s. Thermal resistance (Rct) in units of Km²/W can be converted to clothing insulation units, clo, by dividing by 0.155. 1 clo unit is the amount of insulation that allows a person at rest to maintain thermal equilibrium in an environment at 21° C. (70° F.) in a normally ventilated room (0.1 m/s air movement). The lower the clo value of a fabric or composite, the lower the thermal burden on the person wearing the clothes.

### TEST RESULTS

Tests were conducted on selected composites described in Table 1. The tests included Aerosol Vapor Liquid Assessment Group (AVLAG), DMMP permeation, Water Vapor Transmission Rate (WVTR), air permeability, and thermal resistance (Rct), all using the equipment and test procedures described above.

Samples were evaluated by the AVLAG test for GD and HD permeation after 24 hours. The results are set forth in Table 2, where a lower permeation value is preferred.

TABLE 2

| | GD Permeation | HD Permeation |
|---|---|---|
| Example | (μg/cm²) | (μg/cm²) |
| 1 (MOF A) | 307.0 | 202.0 |
| 2 (MOF B) | 10.0 | 612.0 |
| 3 (MOF C) | 678.0 | 940.0 |

These results indicate that different MOFs may have different selectivities for absorbance and decontamination activity for different hazardous agents.

The effect of binder in the formation process of MOF granules on live agent permeation is shown in Table 3, where a lower permeation value is preferred.

TABLE 3

| | GD Permeation | HD Permeation |
|---|---|---|
| Example | (μg/cm²) | (μg/cm²) |
| 1 (MOF A with Ludox) | 307.0 | 202.0 |
| 4 (MOF A with Chitosan) | 877.0 | 252.0 |

The results indicate that synthetic and natural binders may have different effects on the absorbance and decontamination activity of the multi-layer construction for different hazardous agents.

The effects of carbon form (granules vs fabric) and choice of membrane on live agent permeation is shown in Table 4. All the Examples in Table 4 were made with MOF A, a standard knit inner layer and a standard woven outer layer.

TABLE 4

| Example (carbon | GD Permeation | HD Permeation |
|---|---|---|
| form, membrane) | (μg/cm²) | (μg/cm²) |
| 8 (granules, ePTFE) | 0.01500 (<MDL) | 0.02400 |
| 11 (fabric, ePTFE) | 0.06600 | 0.03000 |
| 9 (granules, | 0.04200 | 0.08700 |
| polypropylene) | | |
| 13 (fabric, polyurethane) | 0.03000 | 0.03600 |

The very slight increase in permeation values when changing from carbon granules (Example 8) to carbon fabric (Example 11) was insignificant, such that the two constructions can be deemed functionally equivalent in this test. Similarly, the change in permeation values when using different types of porous membranes, as shown in a comparison of Examples 8 and 9 and a comparison of Examples 11 and 13, is not considered to be significant.

The effect of outer face cover fabric on live agent permeation is shown in Table 5 for Examples 1, 3, 4, and 5 made with ePTFE and PU membranes.

TABLE 5

| Example (membrane, | GD Permeation | HD Permeation |
|---|---|---|
| outer layer) | (μg/cm²) | (μg/cm²) |
| 11 (ePTFE, std woven) | 0.06600 | 0.03000 |
| 13 (polyurethane, std woven) | 0.03000 | 0.03600 |
| 14 (ePTFE, HD knit) | 0.5300 | 0.01700 |
| 15 (polyurethane, HD knit) | 0.0300 | 0.04700 |

The results shown in Table 5 demonstrate that the change of cover fabric from a woven textile to a HD knit textile may have little significant effect on the overall composite performance.

The effect of each individual component layer (adsorbent, carbon fabric, outer face cover fabric, and porous membrane) on DMMP permeation breakthrough time is shown in Table 6 This data confirms the significant improvement in DMMP breakthrough time achieved with a combination of the zirconium MOF between a carbon layer and a membrane layer.

TABLE 6

| | | | | | DMMP |
|---|---|---|---|---|---|
| | Carbon | | | Outer | breakthrough |
| Sample | form | MOF | Membrane | layer | (minutes) |
| Control A | — | — | — | Std woven | 1 |
| Control B | — | — | ePTFE | Std woven | 8 |
| Control C | Fabric | — | polyurethane | Std woven | 554 |
| Ex. 7 | — | MOF A | polyurethane | Std woven | 325 |
| Ex. 10 | Fabric | MOF A | — | Std woven | 812 |
| Ex. 11 | Fabric | MOF A | ePTFE | Std woven | 961 |
| Ex. 12 | Fabric | MOF A | polypropylene | Std woven | 983 |
| Ex. 13 | Fabric | MOF A | polyurethane | Std woven | 1290 |
| Ex. 15 | Fabric | MOF A | polyurethane | HD knit | 1286 |

The effect of different composite layering (adsorbent layers, carbon fabric, porous membrane, and outer face cover fabric) on WVTR is shown in Table 7 for incumbent Garments 100 and 101, Control Sample D, and Examples 1, 11 and 14.

TABLE 7

| | Carbon | | | Outer | |
|---|---|---|---|---|---|
| Sample | form | MOF | membrane | layer | WVTR |
| Garment 100 | | — | | | approx. 900 |
| Garment 101 | | — | | | approx 1100 |
| Control D | granules | — | — | Std woven | 978.0 |
| Ex. 1 | — | MOF A | — | Std woven | 921.0 |
| Ex. 11 | fabric | MOF A | ePTFE | Std woven | 1022.0 |
| Ex. 14 | fabric | MOF a | ePTFE | HD knit | 119.0 |

The results demonstrate that the change of cover fabric from a woven textile to a HD knit textile may increase WVTR of the composite (Compare Examples 11 and 14) and suggest that inclusion of an ePTFE membrane does not result in a decrease in WVTR. The differences observed in the WVTR values are not statistically significant. The data establish that any additional layers (such as carbon fabric or porous membrane) do not significantly decrease the WVTR, which would have a negative impact on thermal burden on a garment made with the composite. The data also show that the WVTR values of the composites disclosed herein are in the same general range as the WVTR values of incumbent materials Garment 100 and Garment 101.

The effect of outer face cover fabric on air permeability is shown in Table 8 for Examples 11 and 14.

TABLE 8

| Sample | Membrane | Outer layer | Air permeability (cfm) |
|---|---|---|---|
| Example 11 | ePTFE | Std woven | 1.2100 |
| Example 14 | ePTFE | HD knit | 0.6700 |

These results demonstrate that the change of cover fabric from a woven textile to a HD knit textile may reduce air permeability of the composite.

The effect of outer face cover fabric on thermal resistance is shown in Table 9 for Examples 11 and 14. A lower value of thermal resistance is preferred.

TABLE 9

| | | | Thermal |
|---|---|---|---|
| Sample | Membrane | Outer layer | resistance (clo) |
| Garment 100 | | | 0.41 |
| Ex. 11 | ePTFE | Std woven | 0.17400 |
| Ex. 14 | ePTFE | HD Knit | 0.22470 |

These results show that the multi-layer fabric constructions of Examples 11 and 14 have significantly superior thermal resistance compared to the incumbent Garment 100. These results also demonstrate that the change of cover fabric from a woven textile to a HD knit textile may increase thermal resistance (Rct) of the composite.

One advantage of the multi-layer fabric construction as disclosed herein is that the MOF adsorbent, and in particular the zirconium MOF adsorbent, will promote the degradation of certain adsorbed toxic chemical agents, particularly chemical warfare agents. This can be evaluated by exposing a sample under permeation conditions to a known quantity of a toxic agent so that the agent will be adsorbed by the multi-layer construction, then extracting the sample with a solvent and measuring the amount of toxic chemical agent collected in the extraction process. A lower amount of toxic chemical agent extracted indicates that a greater amount of the toxic chemical agent has been decomposed and thereby deactivated by the MOF adsorbent, making the fabric construction safer to handle. The results are shown in Table 10.

TABLE 10

| | | | | GD | HD |
|---|---|---|---|---|---|
| | Carbon | | | Extracted | Extracted |
| Sample | Form | MOF | Membrane | (μg) | (μg) |
| Control | Granules | — | — | 6423 | 6865 |
| Sample D | | | | | |
| Example 1 | — | MOF A | — | 43 | 365 |
| Example 7 | — | MOF A | PU | 12 | 269 |
| Example 13 | Fabric | MOF A | PU | 730 | 1708 |

The data establish that fabric constructions that include a zirconium MOF have significantly less toxic chemical agent extracted than the Control Sample that did not include any MOF, indicating that a significant amount of the toxic chemical agent was decomposed upon adsorption in the fabric constructions containing zirconium MOF.

The Examples herein are illustrative embodiments of the multi-layer fabric construction and methods of making the same. Those of skill in the art will readily appreciate that other embodiments may be made and used within the scope of the claims. Numerous advantages of the disclosure have been set forth. It will be understood, however, that this disclosure is, in many respects, only illustrative. Changes may be made in details, particularly in matters of shape, size, and arrangement of parts without exceeding the scope of the disclosure.

What is claimed is:

1. A multi-layered fabric construction to mitigate airborne toxic chemical agents, the construction comprising:
a. a carbon layer having an inner face and an opposing outer face;
b. a gas-permeable adsorbent-adhesive layer comprising a metal organic framework (MOF) material and an adhesive, said gas-permeable adsorbent-adhesive layer having an inner face and an outer face, the inner face of the adsorbent-adhesive layer facing the outer face of the carbon fabric layer;
c. a vapor permeable layer having an inner face and an opposing outer face, with the inner face of the vapor permeable layer facing the outer face of the adsorbent-adhesive layer; and
d. an outer layer having an inner face and an opposing outer face, and having its inner face facing the outer face of the vapor permeable layer.

2. The multilayered fabric construction of claim 1 wherein the construction is substantially free of air gaps between the layers.

3. The multilayered fabric construction of claim 1 wherein said carbon layer is bound to said adsorbent-adhesive layer by a gas-permeable layer of adhesive.

4. The multilayered fabric construction of claim 1 wherein the adsorbent layer is bound to the vapor permeable layer by a gas-permeable layer of adhesive.

5. The multilayered fabric construction of claim 1 wherein a plurality of columns of adhesive extends through said adsorbent layer to discontinuously bind said carbon fabric layer to said vapor permeable layer.

6. The multi-layer fabric construction of claim 1 wherein said carbon layer comprises activated carbon cloth.

7. The multi-layer fabric construction of claim 1 wherein said carbon layer comprises activated carbon granules.

8. The multi-layer fabric construction of claim 1 wherein said MOF comprises metal nodes comprising zirconium.

9. The multi-layer fabric construction of claim 8 wherein said MOF comprises linker molecules comprising an amino group.

10. The multi-layer fabric construction of claim 8 wherein said MOF is impregnated with an inorganic metal salt.

11. A garment comprising the multilayered fabric construction of claim 1.

12. A method of making a multilayered fabric construction, comprising the steps of:
a. providing a first subassembly comprising a carbon layer having an inner face and an outer face;
b. providing a second sub-assembly comprising an outer fabric having an inner face and an outer face, a vapor permeable layer having an inner face and an outer face, the outer face of the vapor permeable layer toward the inner face of the outer fabric;
c. providing an adsorbent-adhesive combination comprising a MOF material and adhesive; and
d. securing the first subassembly, the second subassembly, and the adsorbent-adhesive combination in a multi-layer fabric construction with the adsorbent adhesive-combination disposed between the first and second subassemblies.

13. The method of claim 12 wherein step (d) is accomplished by roll lamination, heat pressing, or a combination of roll lamination and heat pressing.

14. The method of claim 12 wherein the adsorbent-adhesive combination comprises a mixture of granules comprising a MOF material and granules comprising adhesive.

15. The method of claim 12 wherein the adsorbent-adhesive combination comprises sheets of adhesive with MOF material disposed therebetween.

16. A multi-layer fabric construction comprising a fabric layer and an adsorbent-adhesive layer, wherein the adsorbent of the adsorbent-adhesive layer comprises a zirconium MOF.

17. The multi-layer fabric construction of claim 16 wherein said zirconium MOF includes some linker molecules comprising an amino group.

18. The multi-layer fabric construction of claim 17 wherein at least 55% of the amino groups of the MOF are activated amino groups.

19. The multi-layer fabric construction of claim 16 wherein said zirconium MOF is impregnated with an inorganic metal salt.
